(19) United States
(12) Patent Application Publication
(10) Pub. No.: US 2019/0206238 A1
(43) Pub. Date: Jul. 4, 2019

(54) METHOD AND DEVICE FOR CONTROLLING TRAFFIC IN ORDER TO REDUCE AIR POLLUTION

(71) Applicant: Robert Bosch GmbH, Stuttgart (DE)

(72) Inventor: Volker Hofsaess, Moeglingen (DE)

(73) Assignee: Robert Bosch GmbH, Stuttgart (DE)

(21) Appl. No.: 16/314,790

(22) PCT Filed: May 12, 2017
(86) PCT No.: PCT/EP2017/061467

§ 371 Date: Jan. 2, 2019

(30) Foreign Application Priority Data
Jul. 15, 2016 (DE) 10 2016 213 013.7

(51) Int. Cl. G08G 1/01; G08G 1/08; G08G 1/087; B60W 50/00

(52) U.S. Cl. CPC G08G 1/0145; G08G 1/08; G08G 1/087; B60W 2710/06; B60W 2550/142; B60W 2550/16; B60W 2550/20; B60W 50/00

(57) ABSTRACT

A method for controlling traffic in order to reduce air pollution includes reading in at least one pollution signal that represents at least one parameter of a movement of a vehicle in a predetermined relation to a threshold value and a geographical position of the vehicle; and, based on the pollution signal, outputting a change signal for changing at least one parameter of at least one infrastructure unit in surroundings of the position in order to control the traffic.

### CROSS-REFERENCE TO RELATED APPLICATIONS

The present application is the national stage of International Pat. App. No. PCT/EP2017/061467 filed May 12, 2017, and claims priority under 35 U.S.C. § 119 to DE 10 2016 213 013.7, filed in the Federal Republic of Germany on Jul. 15, 2016, the content of each of which are incorporated herein by reference in their entireties.

### BACKGROUND

U.S. Pat. No. 3,636,934 describes a system for reducing nitrogen oxide emissions of a vehicle due to an acceleration of the vehicle or a gradient angle of a route.

### SUMMARY

Particularly in view of smog and critical air pollutant concentrations in many cities, due to traffic as well, new approaches are required for reducing air pollution.

Example embodiments of the present invention provides a method for controlling traffic in order to reduce air pollution, a device which utilizes this method, and a corresponding computer program.

According to an example embodiment, a method for controlling traffic in order to reduce air pollution includes at least one step of reading-in and one outputting step. In the step of reading-in, at least one pollution signal is read in, which represents at least one parameter of a movement of a vehicle in a predetermined relation to a threshold value and a geographical position of the vehicle. In the outputting step, a change signal is output by utilizing the pollution signal, the change signal being designed for changing at least one parameter of at least one infrastructure unit in surroundings of the position in order to control the traffic.

Advantages achievable with the presented approach include that at least one parameter of a movement of a vehicle, which, for example, identifies increased pollutant emissions of the vehicle, is utilized for controlling the traffic, for example, for smoothing the traffic flow, from this point forward in order to prevent further increased pollutant emissions of the vehicle or of other vehicles in this area. In the step of reading-in, a pollution signal can be read in, in the case of which the parameter of the movement of the vehicle represents a braking movement of the vehicle, since the vehicle generates increases pollutant emissions during braking and when the vehicle starts moving. In this case, the threshold value can be established, for example, as a brake application which corresponds to a reduced acceleration of −2.5 m/s². The change signal can be output when the vehicle falls below this threshold value, i.e., the brakes are applied more forcefully. In this way, with the aid of braking values, a geographical position of a traffic spot can be ascertained, at which forceful braking was carried out. In this case, the change signal can contribute to preventing further forceful braking of other vehicles, for example, by setting a longer green phase of a nearby traffic light, which can be the reason for a back-up of vehicles. Specifically, in the case of forceful braking, in addition to the high pollutant emissions, tire wear debris of the vehicle can additionally pollute the environment. The threshold value can also be established in such a way, however, that the change signal is output already during slight braking in order to control the traffic, for example, during stopped traffic or a traffic jam, in which increased pollutant emissions are also generated.

Additionally or alternatively, in the step of reading-in, a pollution signal can also be read in, in the case of which the parameter of the movement of the vehicle represents an acceleration or deceleration movement of the vehicle on an uphill grade. Frequent braking and starting on uphill grades pollutes the environment to a particular extent, and a preferably unobstructed driving operation is therefore worthwhile in the area of uphill grades. A strong acceleration can also indicate a greater amount of air pollution.

According to an example embodiment, the outputting step can be carried out when, in the step of reading-in, at least a plurality of pollution signals, which encompass the same position within a tolerance range, were read in. A plurality of pollution signals can indicate that many vehicles are involved in the environmental hazard. The more vehicles are involved, the more essential it is to change the traffic situation. Reading in a plurality of pollution signals can also be utilized for verifying a pollution signal first, before a change signal is output.

Advantageously, in the outputting step, a change signal can be output, which is designed for changing a parameter of an infrastructure unit in the form of a signal installation and/or an infrastructure unit in the form of a traffic control system. By way of, for example, longer green phases of a traffic light in an affected area, pollution of the environment can be prevented by ensuring that less braking is required in this area. In areas in which an acceleration that is too high was read in, traffic control systems can display, for example, a lower maximum speed limit.

In order to be able to geographically pinpoint pollution sites and make them more transparent, the method can include a step of generating, in which, by utilizing the at least one pollution signal, a map signal is generated, which is designed for displaying and/or storing the parameter of the movement and/or the position in a map, where the step of generating can be carried out in response to the step of reading-in.

Moreover, an example embodiment of the approach presented here is also advantageous, in the case of which, in the step of generating, the parameter of the movement and/or the position are/is displayed and/or stored in a map depicting an entire territorial unit. Such a territorial unit can be a larger locality, a municipality, a city, or the like, so that the monitoring of a larger contiguous territory becomes possible due to the approach presented here. This makes it possible to monitor or ascertain effects which can arise due to changes in traffic control measures such as the addition of further parking spaces in certain streets.

This method can be implemented, for example, in software or hardware or in a mixed form of software and hardware, for example, in a control unit.

The approach presented here furthermore provides a device which is designed for carrying out, controlling, or implementing the steps of a variant of a method presented here in corresponding units. The object of the approach can also be rapidly and efficiently achieved with the aid of this embodiment variant of the approach in the form of a device.

For this purpose, the device can include at least one processing unit for processing signals or data, at least one memory unit for storing signals or data, at least one interface to a sensor or an actuator for reading in sensor signals from the sensor or for outputting data or control signals to the actuator and/or at least one communication interface for reading in or outputting data which are embedded in a communication protocol. The processing unit can be, for example, a signal processor, a microcontroller, or the like, the memory unit being a flash memory, an EPROM, or a magnetic memory unit. The communication interface can be designed for reading in or outputting data in a wireless and/or wire-bound manner, a communication interface, which can read in or output wire-bound data, can read in these data, for example, electrically or optically from a corresponding data transmission line or output these data into a corresponding data transmission line.

In the present case, a device can be understood to be an electrical device that processes sensor signals and, as a function thereof, outputs control and/or data signals. The device can include an interface, which can be in the form of hardware and/or software. In the case of a hardware design, the interfaces can be part of a so-called system ASIC, for example, which contains highly diverse functions of the device. It is also possible, however, that the interfaces are standalone, integrated circuits or are formed, at least in part, from discrete components. In the case of a software design, the interfaces can be software modules, which are present, for example, on a microcontroller in addition to other software modules.

In an example embodiment, a control of a change signal takes place using the device. For this purpose, the device can access sensor signals, such as a pollution signal. The control takes place via actuators such as a read-in unit and an output unit.

In addition, a computer program product or a computer program including program code is advantageous, which can be stored on a machine-readable carrier or memory medium such as a semiconductor memory, a hard drive memory or an optical memory, and which can be used for carrying out, implementing, and/or controlling the steps of the method according to one of the above-described example embodiments, in particular when the program product or program is carried out on a computer or a device.

Example embodiments of the approach presented here are described in greater detail in the following description of favorable example embodiments and are represented in the drawings, in which identical or similar reference numerals are used for similarly functioning elements represented in the different figures, a repeated description of these elements being dispensed with.

### BRIEF DESCRIPTION OF THE DRAWINGS

FIG. 1 is a block diagram of a device for controlling traffic in order to reduce air pollution according to an example embodiment of the present invention.

FIG. 2 is a flowchart of a method for controlling traffic in order to reduce air pollution according to an example embodiment of the present invention.

FIG. 3 is a flowchart of a method for creating a pollution map in order to identify at least one pollution site using a method for controlling traffic in order to reduce air pollution according to an example embodiment of the present invention.

FIG. 4 shows a visualization of pollution signals in a map according to an example embodiment of the present invention.

### DETAILED DESCRIPTION

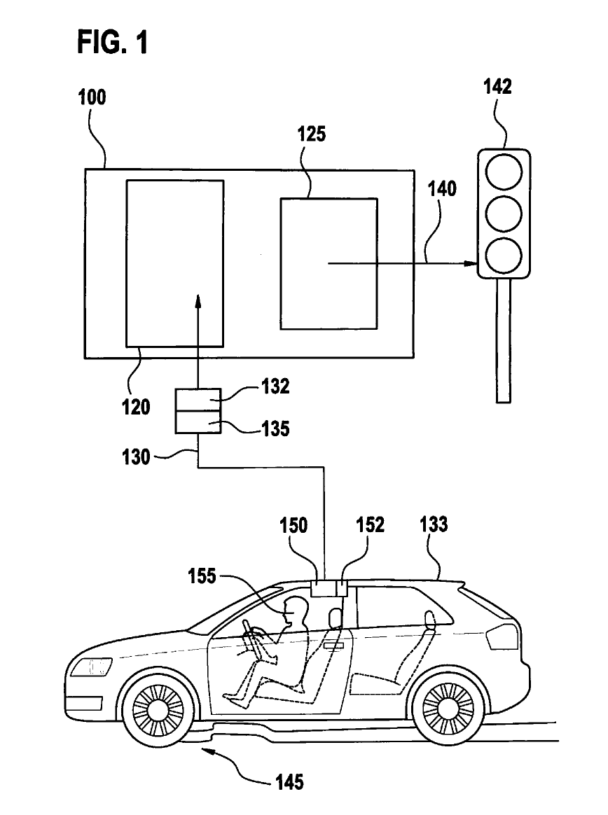

FIG. 1 is a block diagram of a device 100 for controlling traffic in order to reduce air pollution according to an example embodiment of the present invention. Device 100 includes a read-in unit 120 and an output unit 125. Read-in unit 120 is designed for reading-in at least one pollution signal 130 that represents at least one parameter of a movement 132 of a vehicle 133 in a predetermined relation to a threshold value and a geographical position 135 of vehicle 133. Output unit 125 is designed for outputting a change signal 140 by utilizing pollution signal 130, change signal 140 being designed for changing at least one parameter of at least one infrastructure unit 142 in surroundings of position 135, in order to control the traffic.

According to this example embodiment, read-in unit 120 is designed for reading in a pollution signal 130, in the case of which the parameter of movement 132 of vehicle 133 represents a braking movement 145 of vehicle 133. According to this example embodiment, pollution signal 130 is output by a pollution device 150 of vehicle 133. According to this example embodiment, braking movement 145 is sensed by an acceleration sensor 152 of vehicle 133 and is made available for pollution device 150. Braking movement 145 is effectuated by a driver 155 of vehicle 133. According to this example embodiment, change signal 140 is output because read-in pollution signal 130 indicates that the braking movement has fallen below a threshold value of −2.5 m/s². According to this example embodiment, change signal 140 is output to an infrastructure unit 142 in the form of a light signal system, whereby the light signal system is controlled from a red phase to a green phase.

According to an example embodiment, output unit 125 is designed for outputting a change signal 140 for changing a parameter of an infrastructure unit 142 in the form of a traffic control system.

In an example embodiment, read-in unit 120 can also be designed for reading in a pollution signal 130, in the case of which the parameter of movement 132 of vehicle 133 represents an acceleration or deceleration movement of vehicle 133 on an uphill grade. According to this example embodiment, output unit 125 is designed for outputting change signal 140 when at least a plurality of pollution signals 130, which encompass the same position 135 within a tolerance range, has been read in.

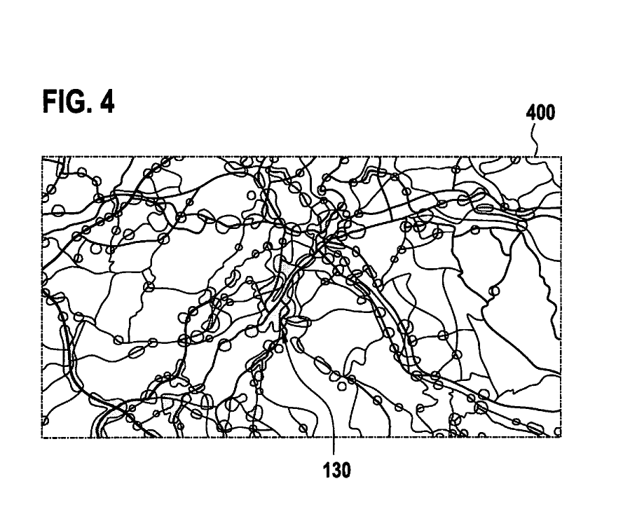

According to an example embodiment, output unit 125 or one further unit of device 100 is designed for generating, by utilizing the at least one pollution signal 130, a map signal for displaying and/or storing the parameter of movement 132 and/or position 135 in a map after pollution signal 130 has been read in. Such a map is represented in FIG. 4.

Described device 100 can also be referred to as a device for predicting local critical concentrations of vehicle emissions in order to smoothen road traffic.

Braking and starting are essential vehicle operating states, in which very high emissions are generated. Smoothing traffic flows, i.e., minimizing the braking operations, thereby directly results in a reduction of vehicle-induced air pollutants. Using a “braking hot spot map” in the form of the map, a traffic control center, for example, is directly capable of controlling, with the aid of device 100, the smoothness of the traffic flows, for example, via phase changes of infrastructure units 142 such as signal systems or traffic control systems. Acceleration values of vehicles 133 on uphill grades also provide indications of the amount of emissions. The vehicle movement data are updateable in short cycles and, therefore, are well suited for carrying out an evaluation across an entire city area and not only in a selective manner. This is the case because, when traffic flows are redirected, new peril points and locations having increased or critical emissions arise. Vehicle 133 is utilized in this case as an “indirect sensor.”

Further possible measures are a reduction of the vehicle speed either by way of the traffic control center or directly by way of speed recommendations, via device 100, concerning vehicles 133 networked by driver assistance systems. Further measures can be a shortening or lengthening of control phases of the signal systems. Direct feedback via instantaneous vehicle movement data is also possible. A change of the measures would therefore be immediately apparent. In this way, for example, a number of the forceful brake applications at a location within hours can be utilized as an indicator of whether the traffic-related measures result in an improvement. Moreover, emergency services can conduct an optimization of the deployment control based on the knowledge of “accident-prone” locations. This includes, for example, a stationing of emergency vehicles such as ambulances and/or emergency physicians based on the knowledge of the locations of frequent forceful brake applications.

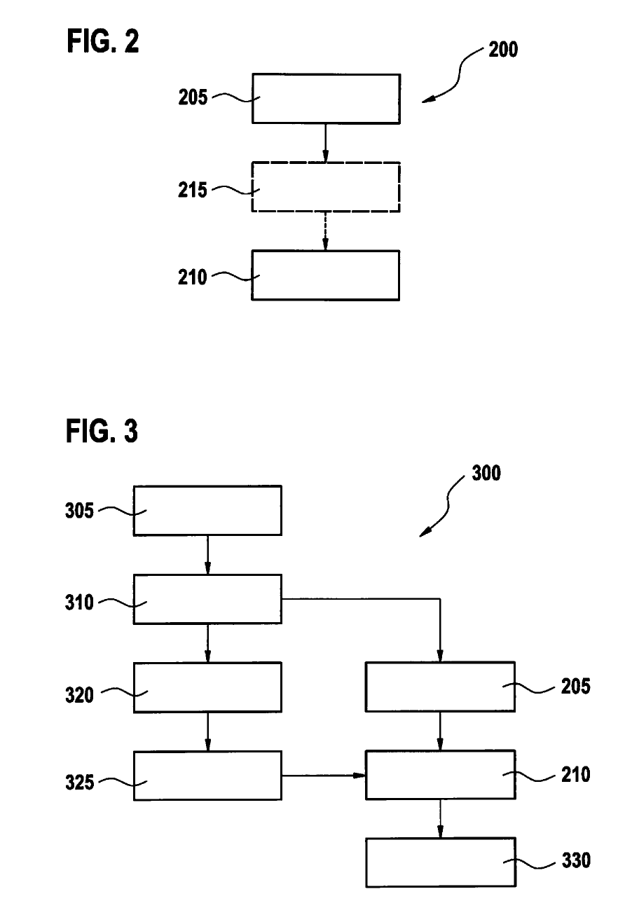

FIG. 2 is a flowchart of a method 200 for controlling traffic in order to reduce air pollution according to an example embodiment. This can be a method 200 which is implementable by device 100 described with reference to FIG. 1. In a step 205 of reading-in, at least one pollution signal is read in, which represents at least one parameter of a movement of a vehicle in a predetermined relation to a threshold value and a geographical position of the vehicle. In an outputting step 210, a change signal is output by utilizing the pollution signal, the change signal being for changing at least one parameter of at least one infrastructure unit in surroundings of the position in order to control the traffic.

Optionally, method 200 includes a step 215 of generating, in which, by utilizing the at least one pollution signal, a map signal is generated, which is designed for displaying and/or storing the parameter of the movement and/or the position in a map, step 215 of generating being carried out in response to step 205 of reading-in.

FIG. 3 is a flowchart of a method 300 for controlling traffic in order to reduce air pollution including further optional steps according to an example embodiment. Step 210 can be step 210 of method 200 described with reference to FIG. 2. In a step 305, at least one present braking situation including, for example, brake applications more forceful than −2.5 m/s², is ascertained from vehicle movement data by the pollution device described with reference to FIG. 1. In a step 310, a “braking hot spot map” is created and, for example, visualized, by the pollution device. Locations having increased braking activity, forcefulness, and number, are made available, in step 205, to the device, which was described with reference to FIG. 1, of the traffic control center or a provider for vehicle push services for driver assistance systems and the “braking hot spot map” is regularly updated in a step 320. In step 210, measures trigger, for example, a reduction of the vehicle speed, for example, via the device of the traffic control center, at the braking hot spots.

Due to the generation of such a braking hot spot map, the city or another entity for ensuring optimal traffic flow control is directly able to detect the entire urban area or location for which the traffic flow is to be optimized. Previously, only spot measurements were carried out at a few local points.

Moreover, measures (for example, changing the traffic routing) implemented by such an entity or city can also be directly evaluated with respect to their effect and, in fact, in a spatially larger area. By comparison, only delayed feedback and local individual measurements are possible nowadays, without being able to utilize synergetic effects.

Steps 325 and 330 represent further possible measures, for example, of the traffic control center. In step 325, an evaluation of the change of the local braking hot spots is carried out with respect to improvement or worsening. On the basis of this evaluation, step 210 can be carried out or adapted. In step 330, gathered information, for example, that braking is frequently carried out at a position due to the presence of a kindergarten, is utilized, for example, for construction site management or planning routes to school.

FIG. 4 shows a visualization of pollution signals 130 in a map 400 according to an example embodiment. This can be a plurality of instances of pollution signal 130 described with reference to FIG. 1. According to this example embodiment, this is a geographical map 400 of the city of Stuttgart, in which, for example, a plurality of pollution signals 130 over a period of time of two days is displayed. According to this example embodiment, pollution signals 130 can also be referred to as movement data, filtered according to more forceful braking operations including a position.

If an example embodiment includes an “and/or” linkage between a first feature and a second feature, this is intended to be read that an example embodiment includes both the first feature and the second feature and a further example embodiment includes either only the first feature or only the second feature.

1-10. (canceled)

11. A method for controlling traffic to reduce air pollution, the method comprising:
obtaining at least one pollution signal that represents at least one parameter of a movement of a vehicle in a predetermined relation to a threshold value and a geographical position of the vehicle; and
based on the at least one pollution signal, outputting a change signal for changing at least one parameter of at least one infrastructure unit in surroundings of the position to control the traffic.

12. The method of claim 11, wherein the at least one parameter includes a representation of a braking movement of the vehicle.

13. The method of claim 11, wherein the at least one parameter includes a representation an acceleration or deceleration movement of the vehicle on an uphill grade.

14. The method of claim 11, wherein the at least one pollution signals on which the outputting is based includes a plurality of pollution signals that are all associated with, within a tolerance range, the same geographical position.

15. The method of claim 11, wherein the infrastructure unit includes a signal system.

16. The method of claim 11, wherein the infrastructure unit includes a traffic control system.

17. The method of claim 11, further comprising generating, based on the obtained at least one pollution signal, an electronic map including a representation of one or both of (a) the at least one parameter of the movement and (b) the geographical position relative to the map.

18. The method of claim 17, wherein the map depicts a territorial unit.

19. A device for controlling traffic to reduce air pollution, the device comprising:
at least one interface; and
a processor;
wherein the processor is configured to:
obtain, via the at least one interface, at least one pollution signal that represents at least one parameter of a movement of a vehicle in a predetermined relation to a threshold value and a geographical position of the vehicle; and
via the at least one interface and based on the at least one pollution signal, output a change signal for changing at least one parameter of at least one infrastructure unit in surroundings of the position to control the traffic.

20. A non-transitory computer-readable medium on which are stored instructions that are executable by a processor and that, when executed in the processor, causes the processor to perform a method for controlling traffic to reduce air pollution, the method comprising:
obtaining at least one pollution signal that represents at least one parameter of a movement of a vehicle in a predetermined relation to a threshold value and a geographical position of the vehicle; and
based on the at least one pollution signal, outputting a change signal for changing at least one parameter of at least one infrastructure unit in surroundings of the position to control the traffic.
